(19) United States
(12) Patent Application Publication
(10) Pub. No.: US 2024/0218220 A1
(43) Pub. Date: Jul. 4, 2024

(54) MOISTURE RESISTANT TWO-COMPONENT ADHESIVE COMPOSITION

(71) Applicant: Dow Global Technologies LLC, Midland, MI (US)

(72) Inventors: Qingwei Meng, Shanghai (CN); Yu Chen, Shanghai (CN); Yi Zhang, Shanghai (CN); Rui Shi, Shanghai (CN); Shaoguang Feng, Shanghai (CN); Hongyu Chen, Shanghai (CN); ChenYan Bai, Shanghai (CN); Paolo Diena, Modena (IT); Yongchun Chen, Shanghai (CN); Yuxi Zhang, Shanghai (CN); Jing Liu, Shanghai (CN); Yanbin Fan, Shanghai (CN)

(21) Appl. No.: 18/558,017

(22) PCT Filed: Jul. 13, 2021
(86) PCT No.: PCT/CN2021/106100

§ 371 Date: Oct. 30, 2023

(51) Int. Cl. C09J 175/08; B32B 7/12; B32B 15/04

(52) U.S. Cl. CPC C09J 175/08; B32B 7/12; B32B 15/043

(57) ABSTRACT

A two-component adhesive composition comprising the reaction product of: a polyol component, comprising a hydrophobic polyol and a phosphate-functional adhesion promoter; and an isocyanate component, comprising the reaction product of an isocyanate monomer and a dimer acid polyester polyol.

### FIELD OF THE INVENTION

The present disclosure relates to an adhesive composition, more particularly to a moisture resistant two-component adhesive composition.

### INTRODUCTION

Adoption of electrical vehicles (EV) has gained momentum all over the world in recent years. A general design of an EV battery pack requires polyurethane (PU) adhesive to bond the battery cell with a cooling plate. The bonding strength can be measured by the shear strength of a lap joint or tensile strength of a butt joint. The bonding interfaces include aluminum alloy, PET film, polycarbonate, etc. Among them the aluminum alloy to aluminum alloy bonding interface is the most promising.

The PU adhesive applied also needs to resist the moisture intake, otherwise accumulation of skinning may occur in the adhesive machine or bubbles may be formed after the PU adhesive is mixed and applied on the substrate(s). Both skinning and bubbles are not acceptable in production because they decrease the line operation efficiency, and lead to quality defects.

To provide moisture resistance, PU adhesives (specifically two component adhesives) are usually formulated with hydrophobic compounds such as castor oil, OH-terminated polybutadiene, and the like. These solutions feature a very weak adhesion for an Al-Al interface. For EV applications, the typical requirements on moisture resistance and adhesion strength are summarized as a greater than 15 hours tacky free time of Part B (Isocyanate part), under 23° C./45% humidity; a greater than 7 MPa mean value of adhesive shear strength on lap-joints at 3a level; and a greater than 6.5 MPa mean value of adhesive tensile strength on butt-joints at 3a level.

It is difficult for current two-component PU adhesives to meet these requirements simultaneously.

Accordingly, there is a need for a PU adhesive with strong bonding strength on substrates, especially Al alloy-Al alloy interface, and inert to the moisture intake during the adhesive application, so the mean value of bonding strength can be reliably kept in the range at 3a level.

### SUMMARY OF THE INVENTION

In a first aspect of the present disclosure, the present disclosure provides a two-component adhesive composition comprising the reaction product of:
A) a polyol component, comprising a hydrophobic polyol and a phosphate-functional adhesion promoter; and
B) an isocyanate component, comprising the reaction product of (I) an isocyanate monomer and (II) a dimer acid polyester polyol.

In a second aspect of the present disclosure, the present disclosure provides a multi-layer structure comprising
a first substrate;
a second substrate; and
an adhesive layer between the first substrate and the second substrate, the adhesive layer formed from the two-component adhesive composition described herein.

In a third aspect of the present disclosure, the present disclosure provides a method of forming a two-component adhesive composition comprising:
(A) providing a polyol component A), comprising a hydrophobic polyol and a phosphate-functional adhesion promoter;
(B) providing an isocyanate component B), comprising the reaction product of (I) an isocyanate monomer and (II) a dimer acid polyester polyol; and
(C) then reacting the isocyanate component B) with the polyol component A) to form the two-component adhesive composition described herein.

In a fourth aspect of the present disclosure, the present disclosure provides use of the two-component adhesive composition in a battery pack.

It is to be understood that both the foregoing general description and the following detailed description are exemplary and explanatory only and are not restrictive of the invention, as claimed.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

### Definitions

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1-7 above includes subranges 1 to 2; 2 to 6; 5 to 7; 3 to 7; 5 to 6; etc.).

Unless stated to the contrary, implicit from the context, or customary in the art, all parts and percents are based on weight and all test methods are current as of the filing date of this disclosure.

The term “composition” refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

A “dicarboxylic acid” is a compound containing two carboxyl (—COOH) groups.

An “isocyanate” is a chemical that contains at least one isocyanate group in its structure. An isocyanate group is represented by the formula: —N═C═O. An isocyanate that contains more than one, or at least two, isocyanate groups is a “polyisocyanate.” An isocyanate that has two isocyanate groups is a di-isocyanate and an isocyanate that has three isocyanate groups is a tri-isocyanate, etc. An isocyanate may be aromatic or aliphatic.

A “polyol” is an organic compound containing multiple hydroxyl (—OH) groups. In other words, a polyol contains at least two hydroxyl groups. Nonlimiting examples suitable polyols include diols (which contain two hydroxyl groups), triols (which contain three hydroxyl groups), and multi-hydroxyl containing polyols.

A “polyether” is a compound containing two or more ether linkages in the same linear chain of atoms.

A “polyester” is a compound containing two or more ester linkages in the same linear chain of atoms.

A “polyester polyol” is a compound that is a polyester and a polyol.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer” (which is used interchangeably with the term “copolymer”) includes bipolymers (employed to refer to polymers prepared from two different types of monomers), terpolymers (employed to refer to polymers prepared from three different types of monomers), and polymers prepared from more than three different types of monomers. Trace amounts of impurities, for example, catalyst residues, may be incorporated into and/or within the polymer. It also embraces all forms of copolymer, e.g., random, block, etc. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

### A. Polyol Component

The two-component adhesive composition comprises the reaction product of A) a polyol component and B) an isocyanate component. The polyol component A) comprises a hydrophobic polyol and a phosphate-functional adhesion promoter. The polyol component A) may optionally comprise a OH prepolymer and/or a polyether polyol.

### Hydrophobic Polyol

A hydrophobic polyol refers to a hydrophobic polyol with at least two hydroxyl groups.

In an embodiment, the hydrophobic polyol is castor oil or its derivatives.

The polyol component A comprises 20-60 wt %, preferably 25-50 wt %, more preferably 28-45 wt %, even more preferably 30-40 wt % of hydrophobic polyol, preferably castor oil, based on the total weight of the polyol component A.

### Phosphate-Functional Adhesion Promoter

Phosphate-functional adhesion promoter is preferably a phosphate modified polyol, more preferably, a phosphate ester polyol. The phosphate ester polyol can be made from a tri-functional propylene glycol, a polyphosphoric acid, and a polyisocyanate. Commercially available examples of the tri-functional propylene glycol suitable for use according to this disclosure include products sold under the trade names VORANOL™ CP-450, VORANOL™ CP-260, VORANOL™ CP-755, and VORANOL™ CP-1055, each available from The Dow Chemical Company. In some embodiments, the phosphate ester polyol has a phosphoric acid content of less than 4 weight percent based on the weight of the phosphate ester polyol, or a phosphoric acid content of from 0 to 3 weight percent based on the weight of the phosphate ester polyol, or a phosphoric acid content of from 1.5 to 2.5 weight percent based on the weight of the phosphate ester polyol. In some embodiments, the phosphate ester polyol has a viscosity less than 40,000 cps at 25° C., or less than 30,000 cps at 25° C., as measured by the method of ASTM D2196. In some embodiments, the phosphate ester polyol has a hydroxyl equivalent weight less than 330 g/mol. In some embodiments, the phosphate ester polyol has from 0 to 100 weight percent, based on the weight of the phosphate ester polyol, of a tri-functional polyether polyol having an equivalent weight less than 2,000 g/mol.

The polyol component A) comprises 0.1-20 wt %, preferably 0.2-15 wt %, more preferably 0.5-12 wt %, even more preferably 1-10 wt %, more preferably 2-8 wt % of phosphate-functional adhesion promoter, preferably a phosphate ester polyol, based on the total weight of the polyol component A).

### OH Prepolymer

The polyol component A) may optionally further comprise a OH prepolymer. The prepolymer is the reaction product of a reaction mixture including (i) an isocyanate monomer, (ii) a polyol, and (iii) a castor oil.

An “isocyanate monomer” is a molecule that contains at least two isocyanate groups. The isocyanate monomer may chemically bind to a polyol to form a prepolymer. Nonlimiting examples of suitable isocyanate monomers include aromatic isocyanates, aliphatic isocyanates, carbodiimide modified isocyanate monomers, and the combinations thereof.

An “aromatic isocyanate monomer” is an isocyanate monomer containing one or more aromatic rings. Nonlimiting examples of suitable aromatic isocyanate monomers include isomers of methylene diphenyl dipolyisocyanate (MDI) such as 4, 4-MDI, 2, 4-MDI and 2, 2′-MDI; or modified MDI such as carbodiimide modified MDI or allophanate modified MDI; isomers of toluene-dipolyisocyanate (TDI) such as 2, 4-TDI, 2, 6-TDI; isomers of naphthalene-dipolyisocyanate (NDI) such as 1, 5-NDI; and combinations thereof.

An “aliphatic isocyanate monomer” is an isocyanate monomer that the isocyanate moisty (—NCO) is not direct connect to aromatic rings. Nonlimiting examples of suitable aliphatic isocyanate monomers include isomers of hexamethylene dipolyisocyanate (HDI), isomers of isophorone dipolyisocyanate (IPDI), isomers of xylene dipolyisocyanate (XDI), other cycloaliphatic isocyanates such as methylene bis-cyclohexylisocyanate (hydrogenated MDI)(HMDI) and cyclohexane diisocyanate, and combinations thereof.

In an embodiment, the isocyanate monomer is selected from a mono-isocyanate monomer, a di-isocyanate monomer, a tri-isocyanate monomer, and combinations thereof. In a further embodiment, the isocyanate monomer is a di-isocyanate monomer.

In an embodiment, the isocyanate monomer is a multifunctional isocyanate monomer with at least two isocyanate groups, or at least three isocyanate groups.

In an embodiment, the isocyanate monomer is selected from MDI, TDI, HDI, and combinations thereof. In a further embodiment, the isocyanate monomer is MDI.

In an embodiment, the isocyanate monomer is selected from carbodiimide modified MDI, carbodiimide modified TDI, carbodiimide modified HDI, and combinations thereof. In a further embodiment, the isocyanate monomer is carbodiimide modified MDI, such as ISONATE 143L from The Dow Chemical Company.

The polyol for preparing the OH prepolymer can be a polyester polyol, a polyether polyol or the combination thereof, preferably, a polyether polyol. A “polyether polyol” is a compound that is a polyether and a polyol. Nonlimiting examples of suitable polyether polyols include polyaddition products of ethylene oxide, propylene oxide, tetrahydrofuran, butylene oxide, and the co-addition and grafted products thereof, the polyether polyols obtained by condensation of polyhydric alcohols, or mixtures thereof, and combination thereof.

Nonlimiting examples of suitable polyether polyols include polypropylene glycol (PPG), polyethylene glycol (PEG), polybutylene glycol, polytetramethylene ether glycol (PTMEG), and combinations thereof. In an embodiment, the polyether polyol is polypropylene glycol (PPG).

Nonlimiting examples of suitable polyether polyols include VORANOL™ 1010 L, a PPG; and VORANOL™ CP450, a glycerine propoxylated polyether triol, each available from The Dow Chemical Company.

In an embodiment, the polyether polyol has a Mw from 50 g/mol, or 100 g/mol, or 400 g/mol, or 450 g/mol to 1,000 g/mol, or 1,500 g/mol, or 2,000 g/mol, or 4,000 g/mol, or 5,000 g/mol.

In an embodiment, the polyether polyol has a hydroxyl number from 30 mg KOH/g, or 50 mg KOH/g, or 75 mg KOH/g, or 100 mg KOH/g to 115 mg KOH/g, or 125 mg KOH/g, or 150 mg KOH/g, or 200 mg KOH/g, or 300 mg KOH/g, or 350 mg KOH/g, or 400 mg KOH/g, or 450 mg KOH/g, or 500 mg KOH/g.

In an embodiment, the polyethyer polyol has one or both of the following properties: (i) a Mw from 50 g/mol to 5,000 g/mol, or from 100 g/mol to 2,000 g/mol, or from 400 g/mol to 1,500 g/mol, or from 400 g/mol to 1,000 g/mol; and/or (ii) a hydroxyl number from 30 mg KOH/g to 500 mg KOH/g, or from 100 mg KOH/g to 400 mg KOH/g, or from 100 mg KOH/g to 150 mg KOH/g, or from 350 mg KOH/g to 400 mg KOH/g.

The polyol component A) comprises 0-30 wt %, preferably 2-28 wt %, more preferably 4-25 wt %, even more preferably 6-20 wt %, or 8-18 wt % or 10-15 wt % of a OH prepolymer, based on the total weight of the polyol component A).

### Polyether Polyol

The polyol component A) may further comprise a polyether polyol. A “polyether polyol” is a compound that is a polyether and a polyol. Nonlimiting examples of suitable polyether polyols include polyaddition products of ethylene oxide, propylene oxide, tetrahydrofuran, butylene oxide, and the co-addition and grafted products thereof, the polyether polyols obtained by condensation of polyhydric alcohols, or mixtures thereof; and combination thereof.

Nonlimiting examples of suitable polyether polyols include polypropylene glycol (PPG), polyethylene glycol (PEG), polybutylene glycol, polytetramethylene ether glycol (PTMEG), and combinations thereof. In an embodiment, the polyether polyol is polypropylene glycol (PPG).

Nonlimiting examples of suitable polyether polyols include VORANOL™ 1010 L, a PPG; and VORANOL™ CP450, a glycerine propoxylated polyether triol, each available from The Dow Chemical Company.

In an embodiment, the polyether polyol has a Mw from 50 g/mol, or 100 g/mol, or 400 g/mol, or 450 g/mol to 1,000 g/mol, or 1,500 g/mol, or 2,000 g/mol, or 4,000 g/mol, or 5,000 g/mol.

In an embodiment, the polyether polyol has a hydroxyl number from 30 mg KOH/g, or 50 mg KOH/g, or 75 mg KOH/g, or 100 mg KOH/g to 115 mg KOH/g, or 125 mg KOH/g, or 150 mg KOH/g, or 200 mg KOH/g, or 300 mg KOH/g, or 350 mg KOH/g, or 400 mg KOH/g, or 450 mg KOH/g, or 500 mg KOH/g.

In an embodiment, the polyethyer polyol has one or both of the following properties: (i) a Mw from 50 g/mol to 5,000 g/mol, or from 100 g/mol to 2,000 g/mol, or from 400 g/mol to 1,500 g/mol, or from 400 g/mol to 1,000 g/mol; and/or (ii) a hydroxyl number from 30 mg KOH/g to 500 mg KOH/g, or from 100 mg KOH/g to 400 mg KOH/g, or from 100 mg KOH/g to 150 mg KOH/g, or from 350 mg KOH/g to 400 mg KOH/g.

The polyol component A) comprises 1-20 wt %, preferably 2-15 wt %, more preferably 4-12 wt %, even more preferably 6-10 wt % of polyether polyol, preferably, glycerine propoxylated polyether triol, based on the total weight of the polyol component A.

### Chain Extenders

The polyol component A) may optionally comprises chain extenders. Nonlimiting examples of suitable chain extenders include glycerine; trimethylol propane; diethylene glycol; propanediol; 2-methyl-1, 3-propanediol; 1,4-butanediol (BDO); and combinations thereof, preferably 1,4-butanediol (BDO).

The polyol component A) comprises 1-20 wt %, preferably 2-15 wt %, more preferably 4-10 wt %, even more preferably 2-6 wt % of chain extenders, preferably, 1,4-butanediol (BDO), based on the total weight of the polyol component A.

The polyol component A) can optionally comprise moisture scavengers, catalysts, flame retardants, rheology modifiers, fillers and the like.

Moisture scavenger absorbs the moistures from the environment before it reacts with the NCO containing groups in adhesive, causing bubble formation problem. An often-used example of moisture scavenger in polyurethane adhesive is molecular sieve.

Catalysts adjust the reaction kinetics to meet the process requirement. Loading more catalyst helps build up initial bonding strength but shorts the pot life. A well-balanced catalyst package is organometallic, including Zn, Bi, and Sn-containing catalysts.

Flame retardants, such as isopropylated phosphate phenol, improve the fire resistance while battery cell is exposed to electricity short.

Rheology modifiers are often included in the either the polyol component A) or the isocyanate component B) or both of the adhesive composition to provide the thixotropic properties for different application needs.

Fillers can be added to either the polyol component A) or the isocyanate component B) or both of the adhesive composition to improve the mechanical strength and lower the cost. Fillers can be selected from silica, CaCO₃, Kaolin, Talc, ATH etc.

### B. Isocyanate Component

The two-component adhesive composition comprises the reaction product of A) a polyol component and B) an isocyanate component. The isocyanate component B) comprises the reaction product of (I) an isocyanate monomer and (II) a dimer acid polyester polyol, which is a NCO-terminated prepolymer.

An “NCO-terminated prepolymer” is the reaction product of an isocyanate monomer and at least one polyol, with the proviso that the at least one polyol includes a dimer acid polyester polyol. An isocyanate prepolymer is an intermediate between monomers and a final polymer.

### Isocyanate Monomer

The isocyanate component B) comprises the reaction product of (i) an isocyanate monomer and (ii) a dimer acid polyester polyol.

An “isocyanate monomer” is a molecule that contains at least two isocyanate groups. The isocyanate monomer may chemically bind to a polyol to form a prepolymer. Nonlimiting examples of suitable isocyanate monomers include aromatic isocyanates, aliphatic isocyanates, carbodiimide modified isocyanate monomers, and the combinations thereof.

An “aromatic isocyanate monomer” is an isocyanate monomer containing one or more aromatic rings. Nonlimiting examples of suitable aromatic isocyanate monomers include isomers of methylene diphenyl dipolyisocyanate (MDI) such as 4, 4-MDI, 2, 4-MDI and 2, 2′-MDI; or modified MDI such as carbodiimide modified MDI or allophanate modified MDI; isomers of toluene-dipolyisocyanate (TDI) such as 2, 4-TDI, 2, 6-TDI; isomers of naphthalene-dipolyisocyanate (NDI) such as 1, 5-NDI; and combinations thereof.

An “aliphatic isocyanate monomer” is an isocyanate monomer that the isocyanate moisty (—NCO) is not direct connect to aromatic rings. Nonlimiting examples of suitable aliphatic isocyanate monomers include isomers of hexamethylene dipolyisocyanate (HDI), isomers of isophorone dipolyisocyanate (IPDI), isomers of xylene dipolyisocyanate (XDI), other cycloaliphatic isocyanates such as methylene bis-cyclohexylisocyanate (hydrogenated MDI or HMDI) and cyclohexane diisocyanate, and combinations thereof.

In an embodiment, the isocyanate monomer is selected from a mono-isocyanate monomer, a di-isocyanate monomer, a tri-isocyanate monomer, and combinations thereof. In a further embodiment, the isocyanate monomer is a di-isocyanate monomer.

In an embodiment, the isocyanate monomer is a multifunctional isocyanate monomer with at least two isocyanate groups, or at least three isocyanate groups.

In an embodiment, the isocyanate monomer is selected from MDI, TDI, HDI, and combinations thereof. In a further embodiment, the isocyanate monomer is MDI.

In an embodiment, the isocyanate monomer is selected from carbodiimide modified MDI, carbodiimide modified TDI, carbodiimide modified HDI, and combinations thereof. In a further embodiment, the isocyanate monomer is carbodiimide modified MDI.

In an embodiment, the isocyanate monomer has a NCO content of no less than 20%, preferably no less than 25%, preferably no less than 28%.

### Dimer Acid Polyester Polyol

The isocyanate component B) comprises the reaction product of (i) the isocyanate monomer and (ii) a dimer acid polyester polyol. A “dimer acid polyester polyol” (or “DAPP” or a dimer acid based polyester polyol) is a polyester polyol containing units derived from dimer acid. In an embodiment, the DAPP is the reaction product of (i) dimer acid, (ii) a polyol, and (iii) optionally, a dicarboxylic acid.

i. Dimer Acid

In an embodiment, the DAPP is the reaction product of a reaction mixture including (i) dimer acid, (ii) a polyol, and (iii) optionally, a dicarboxylic acid.

A “dimer acid” is a dicarboxylic acid compound obtained by allowing a fatty acid having from two to four ethylenic double bonds and from 14 to 22 carbon atoms (hereinafter referred to as “Unsaturated Fatty Acid A”), and a fatty acid having from one to four ethylenic double bonds and from 14 to 22 carbon atoms (hereinafter referred to as an “Unsaturated Fatty Acid B”), to react on double bonds in a dimerization reaction. In an embodiment, Unsaturated Fatty Acid A has two ethylenic double bonds and from 14 to 22 carbon atoms, and the Unsaturated Fatty Acid B has one or two ethylenic double bonds and from 14 to 22 carbon atoms. Nonlimiting examples of suitable Unsaturated Fatty Acid A include tetradecadienoic acids, hexadecadienoic acids, octadecadienoic acids (such as linoleic acid), eicosadienoic acids, docosadienoic acids, octadecatrienoic acids (such as linolenic acid), eicosatetraenoic acids (such as arachidonic acid), and combinations thereof. Nonlimiting examples of suitable Unsaturated Fatty Acid B include the above examples, as well as tetradecenoic acids (tsuzuic acid, physeteric acid, myristoleic acid), hexadecenoic acids (such as palmitoleic acid), octadecenoic acids (such as oleic acid, elaidic acid, and vaccenic acid), eicosenoic acids (such as gadoleic acid), and docosenoic acids (such as erucic acid, setoleic acid, and brassidic acid), and combinations thereof.

The obtained dimer acid is a mixture of dimer acids the structures of which differ according to the binding site or isomerization of a double bond. A non-limiting example of a suitable dimer acid structure is the following Structure (A), Structure (B), Structure (C), Structure (D), or Structure (E):

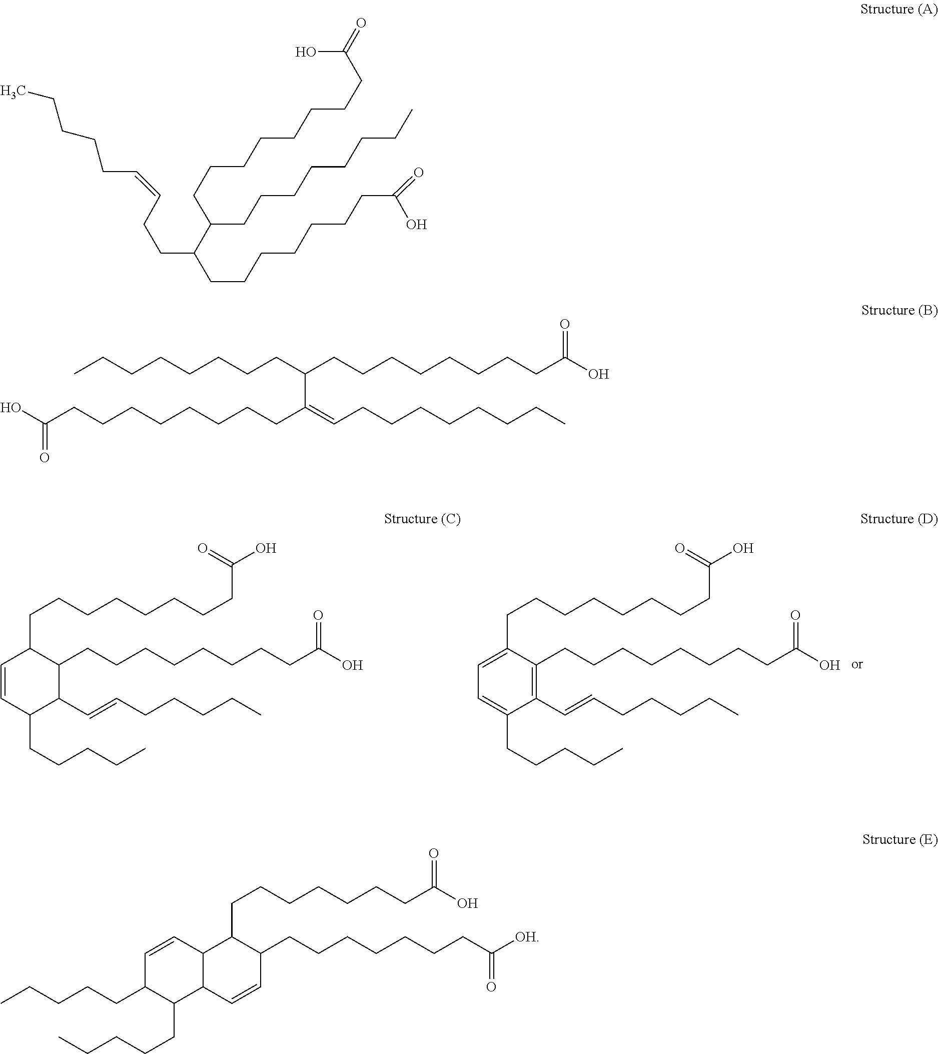 [SMILES: CCCCC/C=C\CCC(CCCCCCCC(=O)O)C(CCCCCCCC)CCCCCCCCC(=O)O ; CCCCCCCC/C=C(/CCCCCCCCC(=O)O)C(CCCCCCCC)CCCCCCCCC(=O)O ; CCCCC/C=C/C1C(CCCCC)C=CC(CCCCCCCCC(=O)O)C1CCCCCCCCC(=O)O ; CCCCC/C=C/c1c(CCCCC)ccc(CCCCCCCCC(=O)O)c1CCCCCCCCC(=O)O ; "or" ; CCCCCC1C=CC2C(C=CC(CCCCCCCC(=O)O)C2CCCCCCCC(=O)O)C1CCCCC]

In an embodiment, the dimer acid is a C36 dimer acid. In a further embodiment, the C36 dimer acid has the Structure (A).

In an embodiment, the obtained dimer acid includes from 0 wt % to 2 wt %, or 4 wt %, or 6 wt % monomer acid and/or from 0 wt % to 2 wt %, or 4 wt %, or 6 wt % polymer acid having a degree of polymerization greater than, or equal to, the degree of polymerization of a trimer acid.

In an embodiment, the dimer acid is unsaturated. An “unsaturated dimer acid” includes at least one carbon-carbon double bond. Structure (A) is an unsaturated dimer acid. A nonlimiting example of a suitable dimer acid is ATUREX™ 1001 (CAS 61788-89-4), available from Aturex Group.

In an embodiment, the dimer acid has an acid value from 150 mg KOH/g, or 160 mg KOH/g, or 170 mg KOH/g, or 180 mg KOH/g, or 190 mg KOH/g, or 194 mg KOH/g to 200 mg KOH/g, or 210 mg KOH/g, or 220 mg KOH/g, or 230 mg KOH/g, or 240 mg KOH/g, or 250 mg KOH/g. In another embodiment, the dimer acid has an acid value from 150 mg KOH/g to 250 mg KOH/g, or from 180 mg KOH/g to 220 mg KOH/g, or from 190 mg KOH/g to 200 mg KOH/g.

In an embodiment, the dimer acid has the Structure (A) and has an acid value from 150 mg KOH/g to 250 mg KOH/g, or from 180 mg KOH/g to 220 mg KOH/g, or from 190 mg KOH/g to 200 mg KOH/g. In a further embodiment, the dimer acid is ATUREX™ 1001 (CAS 61788-89-4), available from Aturex Group.

The dimer acid may comprise two or more embodiments disclosed herein.

ii. Polyol

In an embodiment, the DAPP is the reaction product of a reaction mixture including (i) dimer acid, (ii) a polyol, and (iii) optionally, a dicarboxylic acid.

Nonlimiting examples suitable polyols include diols (which contain two hydroxyl groups), triols (which contain three hydroxyl groups), and combinations thereof. In an embodiment, the polyol includes a diol and a triol.

Nonlimiting examples of suitable diols include 3-methyl 1,5-pentane diol (MPD); 2-methyl-1, 3-propanediol (MPG); ethylene glycol; butylene glycol; diethylene glycol (DEG); triethylene glycol; polyalkylene glycols, such as polyethylene glycol and polypropylene glycol; 1, 2-propanediol; 1, 3-propanediol; 1, 3-butanediol; 1, 4-butanediol; 1, 6-hexanediol; and neopentyl glycol (NPG).

A nonlimiting example of a suitable triol is trimethylolpropane (TMP).

In an embodiment, the polyol is a diol. In a further embodiment, the diol is MPD.

The polyol may comprise two or more embodiments disclosed herein.

iii. Optional Dicarboxylic Acid

In an embodiment, the DAPP is the reaction product of a reaction mixture including (i) dimer acid, (ii) the polyol, and (iii) optionally, a dicarboxylic acid.

The (iii) dicarboxylic acid is not a dimer acid. In other words, the (iii) dicarboxylic acid is structurally distinct and/or compositionally distinct from the (i) dimer acid in the reaction mixture.

Nonlimiting examples of suitable dicarboxylic acids include aliphatic acids, aromatic acids, and combinations thereof. Nonlimiting examples of suitable aromatic dicarboxylic acids include phthalic acid, isophthalic acid, and terephthalic acid.

Nonlimiting examples of suitable of suitable aliphatic dicarboxylic acids include cyclohexane dicarboxylic acid, adipic acid, azelaic acid, sebacic acid, glutaric acid, maleic acid, fumaric acid, itaconic acid, malonic acid, suberic acid, 2-methyl succinic acid, 3, 3-diethyl glutaric acid, 2, 2-dimethyl succinic acid, and trimellitic acid. As used herein, the term “acid” also includes any anhydrides of said acid. Saturated aliphatic and/or aromatic acids are also suitable, such as adipic acid or isophthalic acid.

In an embodiment, the dicarboxylic acid has from four, or five, or six to seven, or eight, or nine, or ten carbon atoms. In another embodiment, the dicarboxylic acid has from four to ten carbon atoms, or from six to eight carbon atoms. In a further embodiment, the dicarboxylic acid has eight carbon atoms.

In an embodiment, the dicarboxylic acid is selected from phthalic acid, isophthalic acid, terephthalic acid, and combinations thereof.

The dicarboxylic acid may comprise two or more embodiments disclosed herein.

iv. Optional Additive

In an embodiment, the DAPP is the reaction product of a reaction mixture including (i) dimer acid, (ii) the polyol, (iii) optionally, the dicarboxylic acid, and (iv) optionally, an additive.

Nonlimiting examples of suitable optional additives include adhesion promoters, chain extenders, catalysts, and combinations thereof.

A nonlimiting example of a suitable adhesion promoter is aminosilane.

Nonlimiting examples of suitable chain extenders include glycerine; trimethylol propane; diethylene glycol; propanediol; 2-methyl-1, 3-propanediol; and combinations thereof.

Nonlimiting examples of suitable catalysts include tetra-n-butyl titanate, zinc sulphate, organic tin catalyst, and combinations thereof.

In an embodiment, the reaction mixture excludes a chain extender.

The optional additive may comprise two or more embodiments disclosed herein.

The isocyanate component B) can optionally include plasticizers, flame retardants, adhesion promoters, rheology modifiers, fillers or the like.

Plasticizers, such as diisononyl phalate, help reduce the skinning accumulated during the application of isocyanate component B).

Flame retardants, such as isopropylated phosphate phenol, improve the fire resistance while battery cell is exposed to electricity short.

Conventional adhesion promoters, such as epoxy silanes, can also be used.

Rheology modifiers, such as fumed silica, are often included in the adhesive composition to provide the thixotropic properties for different application needs. In isocyanate component B), fume silica with hydrophobic surface treatment is often used as a rheology modifier.

Fillers are added in the adhesive composition to improve the mechanical strength and lower the cost. Fillers can be selected from silica, CaCO₃, Kaolin, Talc etc.

The mixture for preparing the reaction product of (i) an isocyanate monomer and (ii) a dimer acid polyester polyol (also called the NCO-terminated prepolymer) typically comprises 60-95 wt %, preferably 65-85 wt %, more preferably 70-80 wt %, of aromatic isocyanates and 5-40 wt %, preferably 15-35 wt %, more preferably 20-30 wt %, of dimer acid polyester polyol, based on the total weight of the mixture for preparing the reaction product of (i) an isocyanate monomer and (ii) a dimer acid polyester polyol.

The isocyanate component B) typically comprises 30-100 wt %, preferably 35-95 wt %, more preferably 40-90 wt %, even more preferably 40-80 wt % or 50-75 wt % or 60-75 wt % of the reaction product of (i) an isocyanate monomer and (ii) a dimer acid polyester polyol, and optionally 0-20 wt %, preferably 1-10 wt %, more preferably 0.5-8 wt %, even more preferably 1-5 wt % or 2-4 wt % of plasticizers, 0-20 wt %, preferably 0.1-10 wt %, more preferably 0.5-8 wt %, even more preferably 0.8-5 wt % or 1-3 wt % flame retardants, 0-10%, preferably 1-8 wt %, more preferably 0.5-6 wt %, even more preferably 0.8-5 wt % or 1-4 wt % of adhesion promoters, 0-10 wt %, preferably 0.5-8 wt %, even more preferably 1-5 wt % or 2-4 wt % of rheology modifiers and 0-70 wt %, preferably 5-65 wt %, more preferably 10-50 wt %, even more preferably 18-45 wt % or 20-40 wt % or 20-30 wt % of fillers, based on the total weight of the isocyanate component B).

### C. Two-Component Adhesive Composition

The two-component adhesive composition is free of, or substantially free of, a solvent.

In an embodiment, the two-component adhesive composition contains an optional conventional additive. The optional additive may be any optional additive disclosed herein, such as plasticizers, chain extenders, flame retardants, adhesion promoters, rheology modifiers, fillers, moisture scavengers, catalysts and the like

The two-component adhesive composition is formed by mixing the polyol component A) and the isocyanate component B) under conditions suitable to react the —NCO groups of the isocyanate component with the hydroxyl groups of the polyol component. In an embodiment, the polyol component A) and the isocyanate component B) are combined and mixed via static mixing equipment or dynamic mixing equipment (such as a meter-mix-dispenser) at a temperature from 15° C., or 20° C., or 25° C., or 30° C., or 35° C., or 40° C. to 45° C., or 50° C., or 55° C.

The Isocyanate Index or (“NCO Index”) is the molar ratio of isocyanate groups in the isocyanate component to the amount of hydroxyl groups in the polyol component. The NCO Index is calculated in accordance with the following Equation (2):

$$\\ \begin{matrix}NCO Index = \frac{( Isocyanate Component NCO wt \% / 42 ) \times mix ratio}{( Hydroxyl Value of Polyol Component / 56106 )} . & Equation ( 2 )\end{matrix}$$

In an embodiment, the two-component adhesive composition has an NCO Index from 1.00, or 1.05, or 1.10, or 1.15 to 1.50, or 1.40, or 1.30, or 1.25. In another embodiment, the two-component adhesive composition has an NCO Index from 1.00 to 1.50, or from 1.05 to 1.40, or from 1.10 to 1.30, or from 1.15 to 1.25.

In an embodiment, the two-component adhesive composition includes the polyol component A) and the isocyanate component B) at an Isocyanate Component B): Polyol Component A) volume ratio from 120:100 to 80:100, or from 115:100 to 90:100, or from 110:100 to 95:100, or from 105:100 to 98:100.

The two-component adhesive composition may comprise two or more embodiments disclosed herein.

### D. Multi-Layer Structure

The present disclosure provides a multi-layer structure. The multi-layer structure includes a first substrate, a second substrate, and an adhesive layer between the first substrate and the second substrate. The adhesive layer is formed from the two-component adhesive composition.

The two-component adhesive composition may be any two-component adhesive composition disclosed herein.

### First Substrate and Second Substrate

The multi-layer structure includes a first substrate and a second substrate.

The first substrate and the second substrate may be the same or different. In an embodiment, the first substrate and the second substrate are the same, such that they have the identical compositions and identical structures.

In an embodiment, the first substrate and the second substrate are compositionally distinct and/or structurally distinct from one another.

It is understood that the below description referring to a “substrate” refers to the first substrate and the second substrate, individually and/or collectively.

A nonlimiting example of a suitable substrate is a film. The film may be a monolayer film or a multilayer film. The multilayer film contains two layers, or more than two layers. For example, the multilayer film can have two, three, four, five, six, seven, eight, nine, ten, eleven, or more layers. In an embodiment, the multilayer film contains only two layers, or only three layers.

In an embodiment, the film is a monolayer film with one, and only one, layer.

In an embodiment, the film includes a layer containing a component selected from ethylene-based polymer (PE), propylene-based polymer (PP), polyamide (such as nylon), polyester, ethylene vinyl alcohol (EVOH) copolymer, polyethylene terephthalate (PET), ethylene vinyl acrylate (EVA) copolymer, ethylene methyl acrylate copolymer, ethylene ethyl acrylate copolymer, ethylene butyl acrylate copolymer, ethylene acrylic acid copolymer, ethylene methacrylic acid copolymer, an ionomer of ethylene acrylic acid, an ionomer of methacrylic acid, maleic anhydride grafted ethylene-based polymer, a polylactic acid (PLA), a polystyrene, a metal foil, a cellulose, cellophane, nonwoven fabric, and combinations thereof. A nonlimiting example of a suitable metal foil is aluminum foil. Each layer of a multilayer film may for formed from the same component, or from different components.

In an embodiment, the film includes a layer containing metal foil.

In an embodiment, the film is a monolayer film having a single layer that is an ethylene-based polymer layer. In a further embodiment, the film is a monolayer film having a single layer that is a polyethylene layer.

The substrate, and further the film, is a continuous structure with two opposing surfaces.

In an embodiment, the substrate has a thickness from 5 μm, or 10 μm, or 12 μm, or 15 μm, or 20 μm, or 21 μm to 23 μm, or 24 μm, or 25 μm, or 30 μm, or 35 μm, or 40 μm, or 45 μm, or 50 μm, or 100 μm, or 150 μm, or 200 μm, or 250 μm, or 300 μm, or 350 μm, or 400 μm, or 450 μm, or 500 μm.

In an embodiment, the substrate excludes cellulose-based substrates, such as paper and wood.

In an embodiment, the first substrate is a monolayer film having a single layer that is a PE layer; and the second substrate is a film having a layer that is a metal foil layer.

The film may comprise two or more embodiments disclosed herein.

The first substrate may comprise two or more embodiments disclosed herein.

The second substrate may comprise two or more embodiments disclosed herein.

The two-component adhesive composition is applied between the first substrate and the second substrate, such as with a Nordmeccanica Labo Combi 400 laminator. In an embodiment, the two-component adhesive composition is applied between the first substrate and the second substrate at a temperature from 20° C., or 30° C., or 40° C. to 50° C., or 60° C., or 70° C., or 80° C., or 90° C.

Nonlimiting examples of suitable application methods include brushing, pouring, spraying, coating, rolling, spreading, and injecting.

In an embodiment, the two-component adhesive composition is applied between the first substrate and the second substrate by conventional coating methods.

In an embodiment, the two-component adhesive composition is uniformly applied between the first substrate and the second substrate. A “uniform application” is a layer of the composition that is continuous (not intermittent) across a surface of the substrate, and of the same, or substantially the same, thickness across the surface of the substrate. In other words, a composition that is uniformly applied to a substrate directly contacts the substrate surface, and the composition is coextensive with the substrate surface.

The two-component adhesive composition and the first substrate are in direct contact with each other. The term “directly contact,” as used herein, is a layer configuration whereby a substrate is located immediately adjacent to a two-component adhesive composition, or an adhesive layer and no intervening layers, or no intervening structures, are present between the substrate and the two-component adhesive composition, or the an adhesive layer. The two-component adhesive composition directly contacts a surface of the first substrate.

The two-component adhesive composition and the second substrate are in direct contact with each other. The two-component adhesive composition directly contacts a surface of the second substrate.

The structure containing the first substrate, the second substrate, and the two-component adhesive composition has the following Structure (P):
First Substrate/Two-Component Adhesive Composition/Second Substrate Structure (P).

The adhesive layer of Structure (P) is formed from curing the two-component adhesive composition. The two-component adhesive composition is formed from mixing and reacting the polyol component A) and isocyanate component B).

In an embodiment, the two-component adhesive composition is cured in an oven at a temperature from 10° C., 20° C., or 35° C. to 40° C., or 45° C., or 50° C.

In an embodiment, the two-component adhesive composition is cured at a temperature from 20° C. to 30° C., preferably 25° C., for a period of from 1 day to 2 days, or 4 days, or 7 days or 10 days.

In an embodiment, the two-component adhesive composition is cured in the absence, or in the substantial absence, of a photo-initiator.

In an embodiment, the two-component adhesive composition is cured in the absence, or in the substantial absence, of water.

In an embodiment, the Structure (P) is cured to form an adhesive layer between the first substrate and the second substrate, thereby forming a multi-layer structure. The multi-layer structure has the following Structure (Q):
First Substrate/Adhesive Layer/Second Substrate Structure (Q).

The multi-layer structure includes the first substrate in direct contact with the adhesive layer, and the second substrate in direct contact with the adhesive layer.

The multi-layer structure includes alternating substrate layers and adhesive layers. The multi-layer structure includes at least three total layers, total layers including the substrate layers and the adhesive layers. In an embodiment, the multi-layer structure includes from three to four, or five, or six, or seven, or eight, or nine, or ten total layers.

In an embodiment, the first substrate is a monolayer film having a single layer that is a metal foil layer and the second substrate is a monolayer film having a single layer that is a metal foil layer, and the multi-layer structure has a lap shear strength of from 7 MPa, or 7.5 MPa, or 8 MPa to 15 MPa, or 13 MPa, or 12 MPa, and/or has a cross tensile strength of from 6.5 MPa, or 7.0 MPa, or 7.5 MPa to 15 MPa, or 13 MPa, or 12 MPa.

In an embodiment, the first substrate is a monolayer film having a single layer that is a metal foil layer and the second substrate is a film having a layer that is a metal foil layer, and the multi-layer structure has a mean value of adhesive shear strength on lap-joints at 3a level of >7 MPa or 7.5 MPa, or 8 MPa to 15 MPa, or 13 MPa, or 12 MPa and a mean value of adhesive tensile strength on butt-joints at 3a level of from 6.5 MPa, or 6.7, or 7.0 MPa, or 7.5 MPa to 15 MPa, or 13 MPa, or 12 MPa.

### E. Method of Forming a Two-Component Solvent-Less Adhesive Composition

The present disclosure also provides a method of forming a two-component adhesive composition comprising:
(A) providing a polyol component A), comprising a hydrophobic polyol and a phosphate-functional adhesion promoter;
(B) providing an isocyanate component B), comprising the reaction product of (I) an isocyanate monomer and (II) a dimer acid polyester polyol; and
(C) reacting the isocyanate component B) with the polyol component A) to form the two-component adhesive composition.

The multi-layer structure can be in the form of a jelly roll or a laminate, preferably in a battery package.

The present disclosure also provides an article containing the multi-layer structure. Nonlimiting examples of suitable articles include packages, such as battery packages.

By way of example, and not limitation, some embodiments of the present disclosure will now be described in detail in the following Examples.

### EXAMPLES

The materials used in the examples are provided in Table 1 below.

TABLE 1
Raw materials used in the examples

| Category | Item Code | Description | Supplier |
|---|---|---|---|
| Polyol | Castor Oil | OH value 163, density | Guangzhou |
| | | 0.961 g/cm3, | Hanhao |
| | | functionality 2.7 | Chemcial Co. |
| | | | Ltd. |
| Polyol | VORANOL CP450 | OH value 373, density | The DOW |
| | | 1.01 g/cm³, | Chemical |
| | | functionality 3 | Company |
| Polyol | VORANOL P 400 | OH value 260, density | The DOW |
| | | 1.01 g/cm³, | Chemical |
| | | functionality 2 | Company |
| Chain Extender | BDO | Molecular weight 90, | SinoChem |
| | | density 1.01 g/cm³, | Group Co. Ltd. |
| | | functionality 2 | |
| Dimer Acid | ATUREX-1001 | Acid value 194-200, | ATUREX |
| | | dibasic acid >98%, | Chemicals |
| Dicarboxylic | Adipic Acid | Molecular weight 146 | Sigma-Aldrich |
| Acid | | | |
| Diol | Neopentyl Glycol | Molecular weight 104 | Sigma-Aldrich |
| Diol | 1,6-Hexanediol | Molecular weight 118 | Sigma-Aldrich |
| Tyzor TBT | catalyst | Density 1.00 g/cm3, | Sigma-Aldrich |
| | | CAS NO. 5593-70-4 | |
| Isocyanate | ISONATE 143L | NCO content 29%, | The DOW |
| | | functionality 2 | Chemical |
| | | | Company |
| Isocyanate | ISONATE 125 | NCO content 33.5%, | The DOW |
| | | functionality 2 | Chemical |
| | | | Company |
| Isocyanate | ISONATE OP 50 | NCO content 33.5%, | The DOW |
| | | functionality 2 | Chemical |
| | | | Company |
| Adhesion | 3-Glycidoxypropyl | Density 1.07 g/cm³ | The DOW |
| Promoter | Trimethoxysilane, | | Chemical |
| | Z-6040 | | Company |
| Flame | IPPP (Isopropylated | Density 1.17 g/cm³ | Suzhou Dongtuo |
| Retardant | Phosphate Phenol) | | Chemical Co. |
| | | | Ltd. |
| Plasticizer | DINP (Diisononyl | Density 0.975 g/cm₃ | Zhuhai |
| | Phalate) | | Liancheng |
| | | | Chemical Co. |
| | | | Ltd. |
| Moisture | Molecular Sieve 3A | Density 2.1 g/cm³ | W. R. GRACE & |
| Scavenger | | | Co |
| Rheology | Fume silica, | Hydrophobically | EVONIK |
| Modifier | AEROSIL R974 | modified, density 2.1 | Industries AG |
| | | g/cm³ | |
| Filler | Silica 606 | Density 2.4 g/cm³ | SIBELCO |

### Synthesis of Dimer Fatty Acid Based Polyester Diol—A:

100 g Neopentyl Glycol, 99 g Adipic Acid and 81.5 g ATUREX-1001 were charged into 500 ml glass reactor and mixed completely. The mixture was heated to 100 TC. When the raw materials turned to liquid, then agitation was started. The temperature was controlled on the proper position and monitored in the whole process. If the top temperature of glass condenser increased above 103° C., the reactor was cooled as soon as possible. When the reaction temperature increased to 220° C., top temperature fell below 100° C., vacuum was started slowly in 30 minutes to 30 mm Hg. The acid value was checked every 30 minutes. A certain amount of catalyst Tyzor TBT was added until acid value was less than 10. The catalyst was added and the reaction system was maintained at 30 mm Hg vacuum condition for more than 1 hour until the OH value of the reaction system reached theoretical value. The mixture was cooled down to 60-70° C., and the final product was collected as Dimer fatty acid based polyester diol—A.

### Synthesis of Dimer Fatty Acid Based Polyester Diol—B:

100 g 1,6-Hexanediol, 353 g ATUREX-1001 were charged into 500 ml glass reactor and mixed completely. The mixture was heated 100° C. When the raw materials turned to liquid, then agitation was started. The temperature was controlled on the proper position and monitored in the whole process. If the top temperature of glass condenser increased above 103° C., the reactor was cooled as soon as possible. When the reaction temperature increased to 220° C., top temperature fell below 100° C., vacuum was started slowly in 30 minutes to 30 mm Hg. The acid value was checked every 30 minutes. A certain amount of catalyst Tyzor TBT was added until acid value of the reaction system was less than 10. The catalyst was added and the reaction system was maintained at 30 mm Hg vacuum condition for more than 1 hour until the OH value of the reaction system reached theoretical value. The mixture was cooled down to 60-70° C., and the final product was collected as Dimer fatty acid based polyester diol—B.

### Synthesis of Phosphate-Modified Polyol

The synthesis of phosphate-modified polyol was described in Example 5 of WO2015/168670 A1: A IL multi-neck round bottom flask was dried in an oven, flushed with dry N₂ for 30 minutes, then charged with VORANOL™ CP 450 polyether polyol (150 g) and placed under an N₂ sweep of 70 mL/min. A syringe was loaded with 115% Polyphosphoric acid (PPA) (4 g) from ALDRICH CHEMICAL Co. The PPA was added dropwise to the polyether polyol with strong agitation. A minimal temperature increase was observed. The reactor contents were heated to 100° C. for 1 hour, then cooled to 45° C. ISONATE™ 125M polyisocyanate (50 g) was added. The temperature rose to about 95° C. from the heat of reaction. Also, there was an increase in viscosity and development of a yellow color. The reactor was then brought to 65° C., and ethyl acetate (40 g) was added to cut viscosity and improve stirring. After 1 hour, the reactor was cooled and the content was packaged (viscosity: 42,750 mPa·s).

### Synthesis of OH-Terminated Prepolymer:

The OH-terminated prepolymer was synthesized in 1,000 ml glass reactor as normal polyurethane pre-polymer preparation process. 12 g ISONATE OP 50 was charged into reactor and kept at 60° C. with nitrogen protection, then 44 g castor oil and 44 g VORANOL P 400 were charged into reactor to mix with ISONATE OP 50. Increase the temperature to 80° C. slowly and hold for 2 hours. The prepolymer was finally charged into a well-sealed container with nitrogen protection for further use.

### Synthesis of NCO-Terminated Prepolymer 1:

75 g ISONATE 143L was charged into 1,000 ml glass reactor and kept at 60° C. with nitrogen protection, then 25 g dimer fatty acid based polyester diol A was charged into reactor to mix with ISONATE 143L. Increase the temperature to 80° C. slowly and hold for 2-3 hour until NCO content meet the theoretical value. Finally, pre-polymer was charged into well sealed container with nitrogen protection for further application.

### Synthesis of NCO-Terminated Prepolymer 2:

75 g ISONATE 143L was charged into 1,000 ml glass reactor and kept at 60° C. with nitrogen protection, then 25 g dimer fatty acid based polyester diol B was charged into reactor to mix with ISONATE 143L. Increase the temperature to 80° C. slowly and hold for 2-3 hour until NCO content meet the theoretical value. Finally, pre-polymer was charged into well sealed container with nitrogen protection for further application.

### Synthesis of NCO-Terminated Prepolymer 3:

75 g ISONATE 143L was charged into 1,000 ml glass reactor and kept at 60° C. with nitrogen protection, then 25 g castor oil was charged into reactor to mix with ISONATE 143L. Increase the temperature to 80° C. slowly and hold for 2-3 hour until NCO content meet the theoretical value. Finally, pre-polymer was charged into well sealed container with nitrogen protection for further application.

### Synthesis of NCO-Terminated Prepolymer 4:

73 g ISONATE 143L was charged into 1,000 ml glass reactor and kept at 60° C. with nitrogen protection, then 24 g dimer fatty acid based polyester diol A and 3 g Phosphate-modified polyol were charged into reactor to mix with ISONATE 143L. Increase the temperature to 80° C. slowly and hold for 2-3 hour until NCO content meet the theoretical value. Finally, pre-polymer was charged into well sealed container with nitrogen protection for further application.

The recipes and theoretical NCO contents of four NCO-terminated prepolymer, along with the neat ISONATE 143L as the control, were summarized in Table 2.

TABLE 2
Isocyanate component used in the examples

| | Example A | Example B | Example C | Example D | Example E |
|---|---|---|---|---|---|
| NCO-terminated | Control | NCO- | NCO- | NCO- | NCO- |
| prepolymer | (Monomeric | Prepolymer 1 | Prepolymer 2 | Prepolymer 3 | Prepolymer 4 |
| | isocyanate) | | | | |
| ISONATE 143L | 100 | 75 | 75 | 75 | 73 |
| Dimer fatty acid | | 25 | | | 24 |
| based polyester diol | | | | | |
| A | | | | | |
| Dimer fatty acid | | | 25 | | |
| based polyester diol | | | | | |
| B | | | | | |
| Castor Oil | | | | 25 | |
| Phosphate modified | | | | | 3 |
| polyol | | | | | |
| Total | 100 | 100 | 100 | 100 | 100 |
| NCO % | 33.5% | 20.7% | 20.7% | 18.7% | 20.5% |

The part B was formulated following the isocyanate components (Table 2) and was summarized in Table 3.

TABLE 3
Part B formulations used in the examples

| Part B | Example A | Example B | Example C | Example D | Example E |
|---|---|---|---|---|---|
| NCO-terminated | 51.81 | 67.72 | 67.72 | 67.72 | 67.72 |
| prepolymer | | | | | |
| DINP | 2.59 | 2.27 | 2.27 | 2.27 | 2.27 |
| (Diisononyl | | | | | |
| Phalate) | | | | | |
| IPPP | 1.30 | 1.13 | 1.13 | 1.13 | 1.13 |
| (Isopropylated | | | | | |
| Phosphate | | | | | |
| Phenol) | | | | | |
| 3-Glycidoxypropyl | 1.94 | 1.70 | 1.70 | 1.70 | 1.70 |
| Trimethoxysilane, | | | | | |
| Z-6040 | | | | | |
| Fume silica, | 3.50 | 3.06 | 3.06 | 3.06 | 3.06 |
| AEROSIL R | | | | | |
| 974 | | | | | |
| Silica 606 | 38.86 | 24.12 | 24.12 | 24.12 | 24.12 |
| Total | 100.00 | 100.00 | 100.00 | 100.00 | 100.00 |
| Tacky Free | 3.75 | 17 | 17.4 | 10.5 | 9 |
| Time, Hrs | | | | | |

Table 3 showed very short tacky free time if aromatic isocyanate is not modified with the dimer fatty acid based polyester polyols (Example A). When dimer fatty acid based polyester polyols were replaced by castor oil, or incorporated together with phosphate-modified polyol, the tacky free times were shortened too much to meet the requirement.

The adhesive formulations, with details in Part A and the corresponding examples of Part B, were summarized in Table 4a. The adhesive application machines are mostly available at 1:1 volume mixing ratio. And to ensure adhesive fully cured, the stoichiometric ratio of 2K PU adhesive is usually set in the range of 1.15-1.35. So, the formulations are designed to meet these requirements. The Volume mixing ratio and stoichiometric ratio were calculated and listed in the Table 4a.

TABLE 4a
Adhesive examples used in the examples

| | | | | | | | | |
|---|---|---|---|---|---|---|---|---|
| CE 1 | CE 2 | CE 3 | IE 1 | IE 2 | IE 3 | IE 4 | IE 5 | IE 6 |

Part A

| | | | | | | | | | |
|---|---|---|---|---|---|---|---|---|---|
| Castor Oil | 43.90 | 32.26 | 33.15 | 32.55 | 31.97 | 31.41 | 30.87 | 31.41 | 36.70 |
| OH Prepolymer | 18.29 | 13.44 | 13.81 | 13.56 | 13.32 | 13.09 | 12.86 | 13.09 | 0.00 |
| VORANOL CP | 10.98 | 8.06 | 8.29 | 8.14 | 7.99 | 7.85 | 7.72 | 7.85 | 9.17 |
| 450 | | | | | | | | | |
| BDO | 5.49 | 4.03 | 4.14 | 4.07 | 4.00 | 3.93 | 3.86 | 3.93 | 3.06 |
| Phosphate- | 7.32 | 0.00 | 0.00 | 1.81 | 3.55 | 5.24 | 6.86 | 5.24 | 6.12 |
| modified polyol | | | | | | | | | |
| 3-Glycidoxypropyl | 0.00 | 2.69 | 0.00 | 0.00 | 0.00 | 0.00 | 0.00 | 0.00 | 0.00 |
| Trimethoxysilane, | | | | | | | | | |
| Z-6040 | | | | | | | | | |
| Molecular | 10.37 | 7.62 | 7.83 | 7.69 | 7.55 | 7.42 | 7.29 | 7.42 | 8.66 |
| Sieve 3A | | | | | | | | | |
| Fume silica, | 3.66 | 2.69 | 2.76 | 2.71 | 2.66 | 2.62 | 2.57 | 2.62 | 3.06 |
| AEROSIL R | | | | | | | | | |
| 974 | | | | | | | | | |
| Silica 606 | 0.00 | 29.21 | 30.02 | 29.48 | 28.95 | 28.45 | 27.96 | 28.45 | 33.23 |
| Total | 100.00 | 100.00 | 100.00 | 100.00 | 100.00 | 100.00 | 100.00 | 100.00 | 100.00 |

Part B

| | | | | | | | | | | |
|---|---|---|---|---|---|---|---|---|---|---|
| Example A | carbodiimide | 140.36 | | | | | | | | |
| | modified | | | | | | | | | |
| | liquid MDI | | | | | | | | | |
| | only | | | | | | | | | |
| Example B | carbodiimide | | 107.03 | 106.47 | 106.44 | 106.41 | 106.38 | 106.36 | | 101.45 |
| | modified | | | | | | | | | |
| | liquid MDI/ | | | | | | | | | |
| | dimer fatty | | | | | | | | | |
| | acid based | | | | | | | | | |
| | polyester | | | | | | | | | |
| | diol − A = | | | | | | | | | |
| | 75/25 | | | | | | | | | |
| Example C | carbodiimide | | | | | | | | 103.96 | |
| | modified | | | | | | | | | |
| | liquid MDI/ | | | | | | | | | |
| | dimer fatty | | | | | | | | | |
| | acid based | | | | | | | | | |
| | polyester | | | | | | | | | |
| | diol − B = | | | | | | | | | |
| | 75/25 | | | | | | | | | |
| ISO Index, | | 1.24 | 1.33 | 1.29 | 1.27 | 1.25 | 1.23 | 1.21 | 1.20 | 1.26 |
| NCO/OH | | | | | | | | | | |
| Volume ratio, | | 1.00 | 1.00 | 1.00 | 1.00 | 1.00 | 1.00 | 1.00 | 1.00 | 1.00 |
| B/A | | | | | | | | | | |

TABLE 4b
properties of the adhesives

| | | | | | | | | |
|---|---|---|---|---|---|---|---|---|
| CE 1 | CE 2 | CE 3 | IE 1 | IE 2 | IE 3 | IE 4 | IE 5 | IE 6 |

Lap-shear Strength, MPa

| | | | | | | | | | | |
|---|---|---|---|---|---|---|---|---|---|---|
| Mean from 5 | | 2.12 | 7.04 | 9.80 | 8.82 | 9.16 | 10.18 | 10.12 | 12.16 | 11.12 |
| measurements | | | | | | | | | | |
| Std. Deviation | | 0.57 | 0.30 | 1.16 | 0.58 | 0.40 | 0.47 | 0.54 | 0.33 | 0.49 |
| from 5 | | | | | | | | | | |
| measurements | | | | | | | | | | |
| Mean at 3σ | Requirement: >7 | 0.40 | 6.13 | 6.33 | 7.07 | 7.95 | 8.78 | 8.51 | 11.17 | 9.66 |
| level | | | | | | | | | | |

Cross-tensile Strength, MPa

| | | | | | | | | | | |
|---|---|---|---|---|---|---|---|---|---|---|
| Mean from 5 | | 3.28 | 8.50 | 11.96 | 14.84 | 13.12 | 17.46 | 16.46 | 17.50 | 15.64 |
| measurements | | | | | | | | | | |
| Std. Deviation | | 0.56 | 1.09 | 5.99 | 2.68 | 0.78 | 2.22 | 3.14 | 2.31 | 2.04 |
| from 5 | | | | | | | | | | |
| measurements | | | | | | | | | | |
| Mean at 3σ | Requirement: >6.5 | 1.59 | 5.22 | −6.00 | 6.81 | 10.78 | 10.81 | 7.05 | 10.58 | 9.51 |
| level | | | | | | | | | | |

Part B isocyanate prepolymer was prepared following the procedure below:
Step 1 Charge NCO-terminated prepolymer into the vessel; then add other liquid components (DINP, IPPP, Z-6040);
Step 2 Apply vacuum and mix with medium stirring rates for 30 min;
Step 3 Charge Silica 606 into the vessel; apply vacuum after powder incorporation; mix with high stirring rates for 30 min;
Step 4 Charge fumed silica into the vessel; apply vacuum after powder incorporation; mix with high stirring rates for 1 hour;
Step 5 Set temperature bath to 80° C.; keep mixing with medium to low stirring rates for 30 min to sustain the temperature;
Step 6 Set temperature bath to 20° C. to cool down to <40° C.;

Tacky free time was tested following procedure below:

Take 10 g part B in a 50 ml Plastic beaker, put the beaker in oven under 45% humidity and 23° C. temperature. Start time recording. Periodically take out the beaker and use a plastic stick to touch the surface of part B softly. With the increasing reaction between part B and moisture, the surface viscosity increases. Stop the time recording when surface of part B is not sticky anymore. The duration is recorded as tacky free time of part B.

Part A polyol mixture was prepared following the procedure below:
Step 1 Charge castor oil, OH-terminated prepolymer, CP450, and BDO into the vessel; then add in phosphate-modified polyol;
Step 2 Heat up to 80° C.; apply vacuum and mix with medium stirring rates for 1 hour to degas;
Step 3 Charge Silica 606 into the vessel, apply vacuum after powder incorporation; mix with high stirring rates for 15 min;
Step 4 Charge Molecular Sieve 3A into the vessel; apply vacuum after powder incorporation; mix with high stirring rates for 15 min;
Step 5 Charge AEROSIL R974 into the vessel; apply vacuum after powder incorporation; mix with high stirring rates for 1 hour;
Step 6 Cool down to <40° C.

### Test Methods:

Lap-joint test coupons were made with the procedure below:
1. Substrate was made by 3003 aluminum alloy with a dimension of 25 mm×12.5 mm.
2. Clean the substrate surface by wiping off with ethanol.
3. Mask out 25 mm×12 mm bonding area by using pressure sensitive tape.
4. Mix the Part A and Part B of adhesive and put in speedmixer at 1,000 rpm for 1 min to make sure thoroughly mixing.
5. Apply 0.5 g to 1.5 g adhesive in the bonding area of the substrate. Put two copper wires with diameter 0.2 mm to control the thickness of adhesive.
6. Along the length direction, stack another masked substrate with the same bonding area contacted head-to-head. Press and fasten the bonding surfaces with two clippers side by side.
7. Cure the adhesive at 25° C. for 7 days.

Butt-joint test coupons were made based on procedure below:
1. Substrate was made by 3003 aluminum alloy with a dimension of 60 mm height and 15 mm diameter.
2. Clean the substrate surface by wiping off with ethanol.
3. Mix the Part A and Part B of adhesive and put in speedmixer at 1,000 rpm for 1 min to make sure thoroughly mixing.
4. Apply 0.5 g to 1 g adhesive on the flat surface of substrate. Put two copper wires with diameter 0.25 mm to control the thickness of adhesive.
5. Stack another cleaned substrate with the flat surface bonded together. Keep the stacked substrates vertically so the bonding surfaces can be constantly fastened by gravity force.
6. Cure the adhesive at 25° C. for 7 days.

Test coupons were assembled on the fixture of Instron test machine (Model: Instron 5566) and tested at strain rate of 5 mm/min for shear strength of lap-joints and tensile strength of butt-joints.

1. A two-component adhesive composition comprising the reaction product of:
A) a polyol component, comprising a hydrophobic polyol and a phosphate-functional adhesion promoter; and
B) an isocyanate component, comprising the reaction product of (I) an isocyanate monomer and (II) a dimer acid polyester polyol.

2. The two-component adhesive composition of claim 1, wherein the dimer acid polyester polyol component comprises the reaction product of a reaction mixture comprising:
A) a dimer acid, and
B) a polyol.

3. The two-component adhesive composition of claim 1, wherein the dimer acid polyester polyol component comprises the reaction product of a reaction mixture comprising:
A) a dimer acid,
B) a polyol; and
C) a dicarboxylic acid.

4. The two-component adhesive composition of claim 1, wherein the hydrophobic polyol is castor oil.

5. The two-component adhesive composition of claim 1, wherein the phosphate-functional adhesion promoter is a phosphate modified polyol.

6. The two-component adhesive composition of claim 1, wherein the two-component adhesive composition has an NCO Index from 1.15 to 1.30.

7. The two-component adhesive composition of claim 2, wherein the dimer acid has the following Structure (A), Structure (B), Structure (C), Structure (D), or Structure (E):

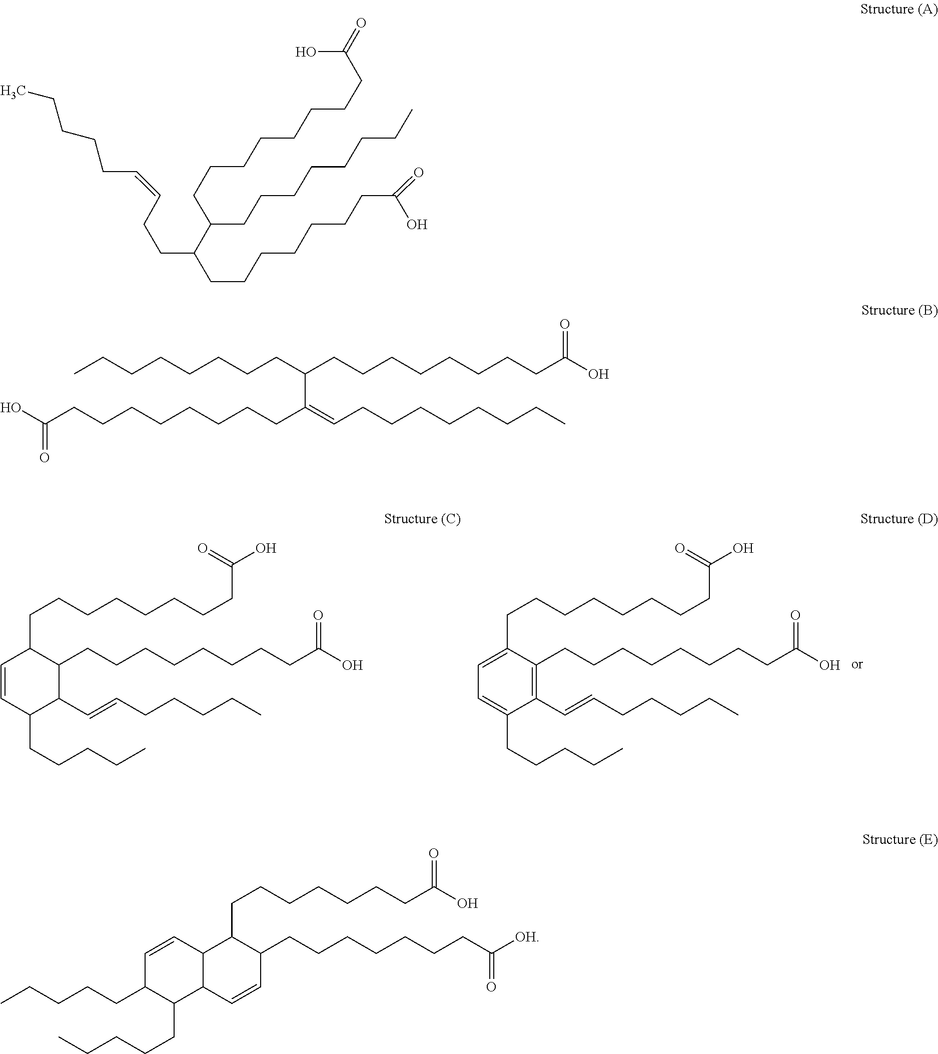 [SMILES: CCCCC/C=C\CCC(CCCCCCCC(=O)O)C(CCCCCCCC)CCCCCCCCC(=O)O ; CCCCCCCC/C=C(/CCCCCCCCC(=O)O)C(CCCCCCCC)CCCCCCCCC(=O)O ; CCCCC/C=C/C1C(CCCCC)C=CC(CCCCCCCCC(=O)O)C1CCCCCCCCC(=O)O ; CCCCC/C=C/c1c(CCCCC)ccc(CCCCCCCCC(=O)O)c1CCCCCCCCC(=O)O ; "or" ; CCCCCC1C=CC2C(C=CC(CCCCCCCC(=O)O)C2CCCCCCCC(=O)O)C1CCCCC]

8. A multi-layer structure comprising
a first substrate;
a second substrate; and
an adhesive layer between the first substrate and the second substrate, the adhesive layer formed from the two-component adhesive composition of claim 1.

9. The multi-layer structure of claim 8, wherein the first substrate and the second substrate are, respectively, a film including a layer containing a component selected from ethylene-based polymer (PE), propylene-based polymer (PP), polyamide (such as nylon), polyester, ethylene vinyl alcohol (EVOH) copolymer, polyethylene terephthalate (PET), ethylene vinyl acrylate (EVA) copolymer, ethylene methyl acrylate copolymer, ethylene ethyl acrylate copolymer, ethylene butyl acrylate copolymer, ethylene acrylic acid copolymer, ethylene methacrylic acid copolymer, an ionomer of ethylene acrylic acid, an ionomer of methacrylic acid, maleic anhydride grafted ethylene-based polymer, a polylactic acid (PLA), a polystyrene, a metal foil, a cellulose, cellophane, nonwoven fabric, and combinations thereof.

10. The multi-layer structure of claim 8, wherein the first substrate is a monolayer film having a single layer that is a metal foil layer and the second substrate is a monolayer film having a single layer that is a metal foil layer.

11. A method of forming a two-component adhesive composition comprising:
A) providing a polyol component A), comprising a hydrophobic polyol and a phosphate-functional adhesion promoter;
B) providing an isocyanate component B), comprising the reaction product of an isocyanate monomer and a dimer acid polyester polyol; and
C) then reacting the isocyanate component B) with the polyol component A) to form the two-component adhesive composition.

12. A use of the two-component adhesive composition of claim 1 in a battery pack.
